(19) United States
(12) Patent Application Publication
(10) Pub. No.: US 2017/0173618 A1
(43) Pub. Date: Jun. 22, 2017

(54) FADE PATTERN FORMATION

(71) Applicant: Heath Moore, Savannah, GA (US)

(72) Inventor: Heath Moore, Savannah, GA (US)

(21) Appl. No.: 15/449,648

(22) Filed: Mar. 3, 2017

Related U.S. Application Data
(63) Continuation of application No. 13/605,902, filed on Sep. 6, 2012.

(51) Int. Cl. B05B 15/04; B05C 17/06; B05C 21/00

(52) U.S. Cl. CPC B05B 15/0456; B05C 21/005; B05C 17/06

(57) ABSTRACT

The invention is a device and method for forming a fade pattern on a large and/or compound-curved surface. The device and method each includes the creation and application of stencil panels to the surface, painting over the stencil panels, and then removing the stencil panels to leave a fade pattern. Also disclosed is a paint coating formed by a method according to the invention.

### CROSS REFERENCE TO RELATED APPLICATION

This application is a continuation of U.S. application Ser. No. 13/605,902 entitled “STENCILING DEVICE AND METHOD,” filed on Sep. 6, 2012, the respective disclosure of which is incorporated by reference in its entirety.

### FIELD OF THE INVENTION

The invention relates to a device and method for applying a fade pattern to a large and/or compound-curved surface, such as a plane fuselage and/or the area(s) at which a plane's wing, engine casing (also called a nacelle), or tail attach to the fuselage.

### BACKGROUND OF THE INVENTION

As used herein the term “fade pattern” refers to a surface having one or more colors that gradually changes (or fades) into one or more other colors. There may be multiple fade patterns on a single surface, and any combination of fades from one or more colors into one or more other colors. Fade patterns are often used on custom cars or motorcycles. To create a standard fade pattern or a car or motorcycle, the painter typically first paints the surface one color. Then, afterwards, the painter uses a paint sprayer including a paint with the second color, and sprays the second color onto the surface to create the fade (or gradual transition from the first color to the second color) by hand. Thus, the fade pattern is dependent upon the skill of the person applying the paint. Fade patterns created by hand are typically fine for relatively small surfaces, such as car or motorcycle surfaces, but are not practical for large surfaces, such as airplane bodies.

A multiple-curved (or compound-curved) surface is one that has two or more intersecting curves. For example, the side of a plane fuselage generally has a single curve to its surface. Where the fuselage meets the wing of the plane, or the tail of the plane, or an engine casing of the plane, however, multiple curved surfaces meet. The same may be true where the vertical portion of the tail of an airplane meets a horizontal portion of the tail, or where the wing is attached to an engine.

Currently, for airplanes and other large surfaces, there is no way to produce a proper fade pattern because the surface is so large that it cannot be done accurately by hand. It is also difficult to apply a fade pattern to compound-curved surfaces, especially to large ones.

### SUMMARY OF THE INVENTION

The present invention is a device and method for applying a fade pattern to a large surface, such as an airplane body, and/or to apply a fade pattern to one or more compound-curved surfaces. The device of the invention includes stencil panels (or panels) applied to the surface. The stencil panels have openings in them for paint to pass through. When paint is applied to the stencil panels (preferably by spraying it on), the paint passes through the openings to create the fade pattern. The stencil panels are then removed, leaving the fade pattern on the surface.

The stencil panels, and the openings therein, are custom-designed for each fade pattern and for each surface that will include a fade pattern. The openings in each stencil panel preferably become smaller, or fewer, or both, as one moves from one side of a stencil panel to another, in order to create a gradual fading of one or more colors to one or more other colors. The openings in each stencil panel that includes openings may be circular, or diamond shaped (which is most preferred), or of any suitable shape and size. Furthermore, the number, size, shape and location of the openings may vary from stencil panel to stencil panel, depending upon the desired esthetics of the final fade pattern on the surface.

One method of creating a fade pattern on a surface, such as an airplane body, is to create a plurality of stencil panels, which may be created based on an artist's rendering of the desired appearance of the fade pattern on a surface. Based on the rendering, the position at which the fade pattern begins on a surface (this position is called the “fade line”) and the distance (or width) of the fade pattern on the surface. As will be understood, the fade pattern “begins” (or “ends”) at two different locations, and the fade pattern is formed between the two lines marking these locations, which are referred to herein as the “first fade line” and the “second fade line.” Depending on the subjective, desired appearance of the fade pattern, there may be more than a first fade line and a second fade line on any surface because the desired width may be intermittent, or the width of the fade pattern may gradually change across the surface. For example, along the surface of a plane, the fade pattern may have different widths as it moves down the fuselage, or across the wing, nacelle, or tail. The different widths, and/or different locations, may be selected for any reason desired to achieve the desired esthetics.

In a preferred embodiment, the surface is preferably marked (or mapped) by first attaching pre-panels, which are preferably comprised of paper, to the surface. Each pre-panel is preferably (a) numbered to help identify its position on the surface, (b) marked in order to align it with any pre-panels adjacent to it, and (c) marked with the position of at least one of the fade lines. A pre-panel may also be marked with a line designating the position of multiple fade lines, so both the first fade line and second fade line (if there are only two) may be marked on the pre-panel. Each pre-panel is also marked with the location of any irregularities on the surface, such as the location of doors, windows, and hatches that will affect the size and shape of the final stencil panels.

The pre-panels are then removed from the surface and are scanned into a computer program that designs a continuous stencil panel image based on the scanned pre-panel images. The program stores the dimensions of each pre-panel, and its number and various markings. The program creates the relevant portion of the fade pattern for each of the stencil panels onto the continuous stencil panel image by configuring a pattern of openings (although some of the individual stencil panels may not have openings and may serve only as masks to block the paint, so some portions of the continuous stencil panel image may not have openings), one or more markings for each stencil panel that will be used to locate the stencil panel relative to adjacent stencil panels, and numbers to identify to which pre-panel the relevant stencil panel corresponds, so as to assist in positioning it properly on the surface.

Using information from the computer program, the openings are punched into a continuous section of stencil panel material (which is preferably a vinyl mask) by any appropriate punch machine, which is known to those skilled in the art. The number for each individual stencil panel, the marks to align each stencil panel with any adjacent panels, and mapping marks (which were added to map irregularities on the surface, as previously described) are also applied to the continuous stencil panel material in any suitable manner, such as by printing or stamping. The program also marks the shape and size of each individual stencil panel on the continuous section. Afterwards, the individual stencil panels are cut from the continuous material using any suitable method. Alternatively, the individual stencil panels could be cut by a machine as or after the continuous section is being punched and having indicia and markings applied.

The individual stencil panels are then applied to the surface, such as a fuselage or other sections of a plane that are to receive the fade pattern. Once the stencil panels are properly positioned on the surface, paint is applied to the stencil panels and it passes through the openings in the stencil panels and onto the surface to form the fade pattern. The stencil panels are then removed to reveal the fade pattern. If desired, any part of the fade pattern in which the lines are not crisp (because of paint bleed through or under a stencil pattern) can be touched up by hand. Also, a clear protective coat may be placed over the fade pattern.

Furthermore, the invention may include intermediary steps wherein the fade pattern is reviewed before being finalized.

### BRIEF DESCRIPTION OF THE DRAWINGS

FIG. 1 is a side view of a rendering of a plane showing a fade pattern applied according to an aspect of the present invention.

FIG. 2 is the opposite side view of the plane rendering of FIG. 1.

FIG. 3 shows the under nose detail of the plane rendering of FIG. 1.

FIG. 4 shows the top nacelle detail of the plane rendering of FIG. 1.

FIG. 5 shows the left under wing detail of the plane rendering of FIG. 1.

FIG. 6 shows the plane rendering of FIG. 2 with stenciling panels superimposed on it.

FIG. 6A shows an enlarged view of some of the panels of FIG. 6 on an air scoop of the plane of FIG. 1.

FIG. 7 shows the stenciling panels applied to the right cowling.

FIGS. 8A-8D show an example of a stencil pattern with diamond-shaped openings used to create a fade pattern of the present invention.

FIG. 9 is a perspective view of a side of a plane fuselage having pre-panels applied according to an aspect of the invention.

FIG. 10 is a rear, perspective view of the plane of FIG. 9.

FIG. 11 is a side, perspective view of the plane of FIG. 9.

FIG. 12 is a view along the side of the plane of FIG. 1 showing a close up view of the fade pattern.

FIG. 13 is a top, perspective view of the plane of FIG. 1 after the fade pattern has been applied to the top, rear portion of the plane, and showing other portions of the plane masked.

FIG. 14 shows an exemplary laser that can be used to create a line on a surface.

FIG. 15 shows a partial, side view of the plane of FIG. 1 with paper pre-panels attached and a fade line being drawn on the pre-panels.

FIG. 16 is a partial, side view of the plane of FIG. 1 showing part of the engine cowling, wherein the fade pattern is being reviewed by placing mock stencil panels with the fade pattern printed thereon onto the plane.

FIG. 17 is a partial, side surface of the plane of FIG. 1 with pre-panels attached and the fade line drawn onto the pre-panels.

FIG. 18 is a partial, side view of the plane of FIG. 1, which has pre-panels applied, wherein the pre-panels are marked with mapping and alignment indicia.

FIG. 19 is an underside, rear view of the plane of FIG. 1 showing pre-panels attached and a fade line drawn on the pre-panels.

FIG. 20 is a partial, side view of the front of the plane depicted in FIG. 1 with pre-panels attached.

### DETAILED DESCRIPTION OF PREFERRED EMBODIMENTS

A preferred embodiment of a method of the present invention first involves the creation of a plurality of stencil panels that are used to create a fade pattern on a surface (also called the “main surface”). The stencil panels are then applied to a surface to be painted to create the fade pattern, the paint is then applied to the stencil panels, and the stencil panels are then removed to leave the fade pattern on the surface.

The overall appearance of the fade pattern is based on subjective esthetics, and it can be modified by a user in any manner according to the invention. The appearance of the fade pattern can be reviewed before being placed on a surface by any suitable method, including one or more of: (1) computer simulation, (2) creating a full-size (or model size) continuous section of material that includes openings or markings that correspond to the fade pattern, and then placing this onto a surface, (3) creating individual stencil panels (or creating individual panels made of a less expensive material, such as paper), which can be placed on the surface to which the fade pattern is to be applied, or to an alternate surface.

### DEFINITIONS

Concept Art: Concept art shows how the desired fade pattern will appear on a surface. This can be provided in a scaled (i.e., such as a ratio or 1:10 or 1:25, or any suitable scale), two-dimensional version of the surface to which the fade pattern is to be applied, such as by using a computer program or a print out from a computer program. The concept art may be created by utilizing a blueprint of the device that includes the surface to which the fade pattern will be applied. However, any suitable method may be utilized, such as by using a computer program, such as ADOBE ILLUSTRATOR to create the fade on the scanned image.

Paint mask or vinyl mask. This is a roll of flexible vinyl material with an adhesive backing that will adhere to the surface to which the fade pattern will be applied. Such material is known to persons skilled in the art. The vinyl mask is a preferred material used to create the individual stencil panels, although any suitable material may be used. This material should be resistant to solvent paint (if solvent-based paint will be used to paint the fade pattern), so when the paint is sprayed on the stencil panels, the stencil panels do not dissolve or otherwise lose the characteristics that make them suitable for use.

The vinyl mask, and stencil panels made from the vinyl mask, have three basic components: (1) a thin, flexible, vinyl sheet material, (2) an adhesive on one side of the vinyl material, and (3) a backing to cover the adhesive. Vinyl masks come in rolls of various lengths and widths. A preferred vinyl mask comes in a roll 40″ wide by 150′ long, although any suitable size may be used. One such vinyl mask is ORACAL paint mask vinyl, and another is made by AVERY.

Transfer tape. Transfer tape is a light/adhesive masking tape material that comes in rolls. One such transfer tape is RITE tape. Use of the transfer tape is optional.

Preferably, the transfer tape is selected to be about the same width and at least as long as the vinyl mask. The transfer tape is applied on the vinyl side of the vinyl mask, opposite the side of the adhesive and paper backing, and is placed onto the vinyl mask after the vinyl mask is cut with openings and marked, as explained herein. The transfer tape is pressed onto the stencil panel to temporarily adhere a stencil panel to the surface to which the fade pattern will be applied, and is removed after the stencil panels are applied to the surface using the adhesive backing on the stencil panels.

Masking (or painter's) tape. This is standard masking or painter's tape (which has a relatively light adhesive backing). Use of the masking tape is optional. This may be used on an edge (preferably the top edge) of each stencil panel to initially place each of the stencil panels on the surface, to be certain that the stencil panels align properly prior to attaching each stencil panel with the transfer tape. If a stencil panel must be removed from the surface and repositioned, the masking tape makes this easier.

If masking tape is used to temporarily adhere the panels to the surface, the stencil panel does not have to be removed from the surface in its entirety to remove the backing and adhesively apply the stencil panel directly to the surface. The stencil panel could just be lifted up in order to expose and remove its backing and then adhere the stencil panel to the surface utilizing the adhesive backing.

Squeegee. This is an optional tool for securing the stencil panels to the surface. Preferably, it is a flat piece of plastic roughly the size as a credit card, and is known to persons skilled in the art. This tool is used to help press the stencil panels onto the surface, and any suitable device could be used for this purpose.

### Determining the Fade Line and Fade Pattern Width

A fade line is determined for the surface, preferably by using a laser-line projection device, which is known by those skilled in the art. Alternatively, it could be manually measured and drawn onto the surface. The position of the fade line is subjective and determined based on the desired esthetics of the fade pattern. For a surface, especially a complex surface with multiple curves and/or apparatus (such as a plane, which has a fuselage, wings and a tail), there may be more than one fade line, and the fade line (and the resulting fade pattern) may be applied intermittently to the surface. The width of the fade pattern is also determined, and is again subjective and based on the desired esthetics. The width and position of the fade pattern may vary along the surface.

### Creating Pre-Panels

The pre-panels may be formed by first cutting paper (or another suitable material) into pieces and applying these pre-panels to the surface, preferably by taping them onto the surface. The manner in which the pre-panels are cut, shaped and attached to the surface can be any manner suitable to ultimately create stencil panels to create the fade pattern on the surface. Preferably, the pre-panels are formed of grid paper (or other suitable material), wherein the grids are 2″×2″ each. With such material an operator can program the computer program to recognize the scale in accordance with the grid pattern. For example, if the grid pattern is 2″×2″, and the markings and indicia are marked on the grid pattern of each pre-panel, the computer program will recognize the relative position of each indicia and marking relative the dimensions of the grid pattern on an individual pre-panel. Use of a grid pattern, however, is optional and is for the convenience of a user placing markings and indicia on the pre-panels. The use of the grid pattern can enable a user to, after scanning the pre-panels into a computer program, scale them to the surface rendering. In this manner, the fade pattern, particularly the part of the fade pattern on compound-curved surfaces, can be checked visually on the two-dimensional rendering for aesthetic accuracy. However, as long as the computer program includes the dimensions of the pre-panel, its location on the surface, the position of at least the first fade line or the second fade line on the pre-panel, the width of the fade pattern, and the indicia showing where relevant surface structures are located, it can create the proper, corresponding stencil panel as described herein.

Once the pre-panels are placed on the surface, the fade line is marked onto each relevant pre-panel, such as by using a laser marker to create the fade line (and then marking the pre-panel, for example, with a marking pen, with the fade line). As previously mentioned, more than one fade line defining the width (or possibly widths) of the fade pattern may be marked on each relevant pre-panel. The mapping starting and stopping points are at any suitable location on the surface in order to properly map the fade pattern.

Each pre-panel is preferably numbered to identify where it was positioned on the surface and is also marked with one or more markings (or indicia) to show where it is to be aligned with any adjacent pre-panel(s).

For a surface, such as the surface of a plane, the pre-panels are also preferably used to map any irregularities on the surface that may affect the size and shape of the stencil panels. Such irregularities include the location and spaces between windows, hatches, and doors.

This mapping of irregularities on the surface is not necessary if it is not required to form stencil panels that will create the desired fade pattern.

Some portions of the surface may be mapped using pre-panels, while other portions may be mapped using computer modeling. Preferably, for an airplane, each side of the plane may be mapped separately, since there may be slight variations between one side and the other. If both sides are the same, only one side needs to be mapped. The second side may also be partially mapped to only map the area(s) that are different than the first side. For example, one side may have a hatch that would affect the size or shape of a stencil panel, whereas the other side may not have a hatch.

If pre-panels are used (which is preferred), they are also cut to size so as to be applied to and map any compound-curved surfaces so the pre-panels conform to such surfaces without crimping or buckling. In this manner, the compound-curved surface is accurately mapped so stencil panels can be created for it, and a fade pattern can be applied to the compound-curved surface.

After being applied to the surface, and marked as appropriate, the pre-panels are then removed from the surface and scanned into a computer program such as PHOTOSHOP, which creates images of the pre-panels. Utilizing these pre-panel images, the program creates an image of a continuous stencil. The program applies openings to the continuous section based upon input by a user, who can adjust the size, number of openings, and position of the openings along the continuous stencil to create the proper fade pattern. Further, other information may be input into the computer program to assist in creating the fade pattern (if such information is not included on the pre-panels), such as: the position of first fade line, the position of the second fade line, the position of any other fade lines, and the width of the fade pattern at different locations on the surface. Furthermore, the computer program itself may create a portion of the continuous stencil that does not correspond to a pre-panel based on input from the user. The computer program also determines the size and shape of each stencil panel in the continuous stencil.

### Evaluating the Fade Pattern

Prior to forming the stencil panels, the fade pattern may be evaluated for esthetics in one or more of a number of ways. One way is to view the fade pattern applied to a surface modeled using a computer program on a computer screen. Another way is to print a continuous strip of material (generally using paper) with the positions of the openings marked to show how the fade pattern will look, and position the continuous piece on the surface to determine how the fade will appear. Alternatively, individual mock stencil panels could be formed, preferably by using paper and marking the paper with the positions of the openings that will form the fade pattern, and then applying this to the surface (in this manner the mock stencil panels can fit around compound-curved surfaces).

### Adjusting for Compound Curves

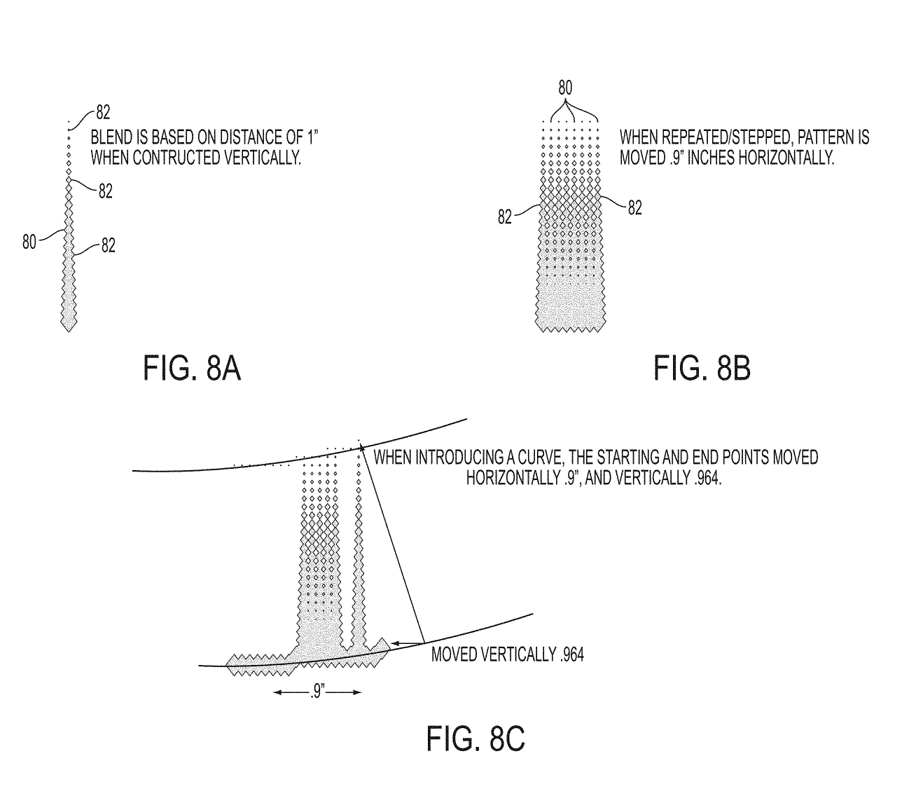

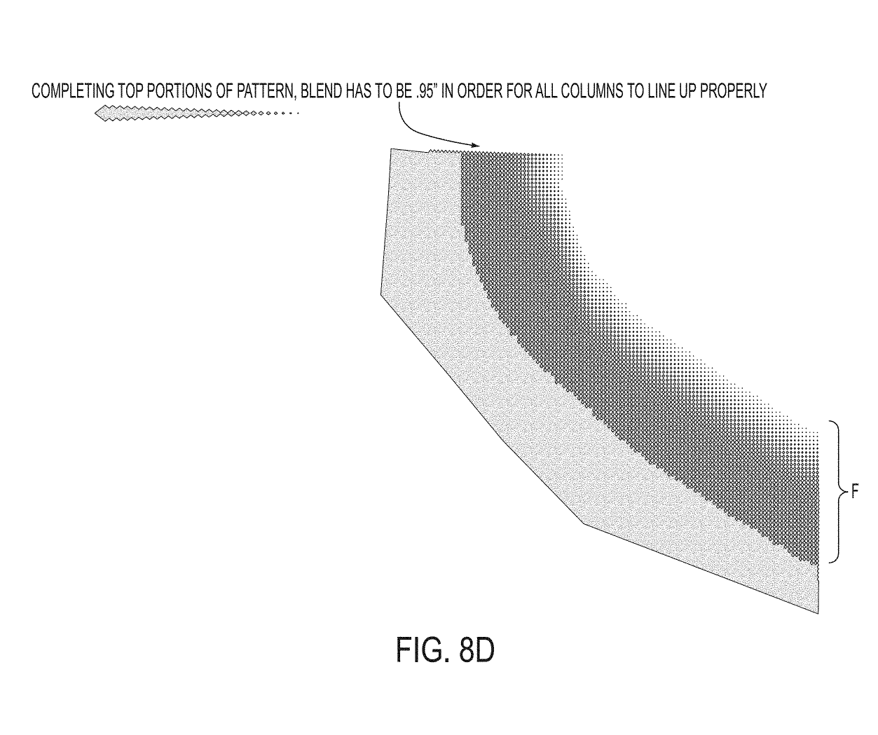

In the preferred embodiment, the operator inputs information to adjust each line horizontally and vertically, and determine the size of each opening, all for esthetics, and the computer program creates the portion of the fade pattern to be applied to the continuous stencil, and hence to each stencil panel. Referring to FIGS. 8A-8D, to make a fade pattern compound-curved surface, the fade must be adjusted vertically and horizontally by the operator based on skill and the desired subjective outcome to achieve the final desired appearance to create a pattern fitting the compound-curved surface. The vertical and/or horizontal displacement of each line forming the fade pattern for each compound-curved surface is unique depending upon the surface and the desired, finished appearance.

Depending upon the curvature and other surface details upon which the fade pattern is applied, the operator may make subjective adjustments to create a more appealing appearance to the fade pattern. For example, the operator may create a more distorted fade by creating additional openings in one or more stencil panels, and/or by making the fade pattern longer in places.

The fade pattern could also potentially be created by using graphical rendering software that could use pictures of the surface to digitally create the fade pattern on a computer, although this would not be capable of creating a fade pattern for compound-curved surfaces.

In the preferred embodiment, the fade pattern is created by moved vertically and horizontally to go around a curve (including a compound curve) on the surface. As shown in FIGS. 8A-8D, the pattern that appears to be a smooth curve from a distance is actually a series of straight lines that have a different horizontal and vertical displacement from adjacent lines, but when viewed from even a relatively short distance away the overall appearance is as a smooth curve. In this embodiment, each vertical column of openings is 0.95″ apart from each adjacent column. Each line of openings is moved horizontally by 0.90 inches and vertically 0.95 inches to create a curved fade pattern across a surface wherein the fade pattern moves downward or upward along a compound-curved surface. The horizontal and vertical movement may be adjusted, however, by an operator, depending on the desired, subjective appearance of the fade especially to compensate for compound-curved surfaces. Referring to Step 3 (FIG. 8C), the entire pattern is moved up slightly. The amount of the fade, positioning, and size of the openings on each stencil pattern depend on the type and size of surface, the fade pattern, and the amount and type of curvature.

The vertical and/or horizontal displacement of the lines to create the illusion of a curve can be adjusted by the operator based on the surface, amount of curvature, and desired esthetics.

In a preferred embodiment, each line of openings should be 0.95″ inch apart in order for the columns to line up properly. The 0.95″ is measured from the center of each opening (which in this embodiment are diamond shaped) to the center of the next opening (either vertically or horizontally). So, when the fade pattern is created, the vertical and horizontal openings should line up as closely as possible in the vertical direction and the horizontal direction because if they do not, the fade pattern may not appear visually correct. So, the openings in each stencil panel should preferably be aligned horizontally and vertically, and the openings should preferably align horizontally and vertically from stencil panel to adjacent stencil panels.

There are different ways to create a fade pattern on the stencil panels. Once programmed, using a program such as ADOBE ILLUSTRATOR, the computer could automatically generate the distance and the pattern between the first fade line and the second fade line, which are, respectively, where the fade begins, and where the fade ends. The pattern could be of any desired type. For example, instead of a gradual fade, it may be gradual for part of the width and then rapidly fade into the next color(s), or it could fade towards one color(s) and then fade back. The size, location and number of openings that form the fade pattern are subjective and the movement is subjective. Since there is one color on one side of the fade pattern and a second color on the other side of the fade pattern, (or there could be multiple colors on either side).

Many times the only thing that must be determined is the position of either the first fade line or the position of the second fade line. In Example 1 described below, the fade pattern is 19″ wide, although it could be of any suitable width.

### Creating the Stencil Panels

The stencil panels can either be created manually or by complete computer modeling of the surface to which the fade pattern is to be applied, or by a combination of manual procedures and computer modeling. A preferred method to create the stencil panels is to form pre-panels, attach them to the surface and mark them, as described above.

Once the computer program has created the continuous stencil using the inputted information, the program directly or indirectly controls a machine to punch the openings in a roll of vinyl mask and the numbers of each pre-panel and indicia to align a stencil panel (that will ultimately be cut from the vinyl mask) with adjacent stencil panels are marked on the vinyl mask along with lines showing where the individual stencil panels are to be cut. In one embodiment each of the openings is marked or colored, and after the openings are punched, an operator manually removes the excess plastic by hand.

The vinyl mask roll is then cut into individual stencil panels. This could be done by a machine or by hand, and may be done as the vinyl mask is being marked and the openings are being punched.

There may be a stencil panel to correspond to each of the pre-panels (and each stencil panel may be the same dimension as the corresponding pre-panel, although that is not required). Further, there may be multiple stencil panels that correspond to a single pre-panel or one stencil panel that corresponds to multiple pre-panels.

Each relevant stencil panel has part of the fade pattern formed onto it (it being understood that one or more of the stencil panels may not include part of the fade pattern and may act solely as a mask to block paint from touching the surface). Ultimately, after the stencil panels are applied to the surface, paint is applied through the openings to create the fade pattern.

### Applying the Stencil Panels

Once formed, the stencil panels are applied to the surface, in the same location as the corresponding pre-panel for each (if relevant). In a preferred embodiment, transfer tape is applied to the surface of each stencil panel that includes openings, wherein the transfer tape is applied on the side opposite the adhesive on the stencil panel. It is also preferred that a strip of masking tape be applied to one or more edges (and most preferably just the top edge) of each stencil panel.

Each stencil panel is then applied to the surface by identifying its location on the surface using the number marked on it. Each stencil panel is preferably first applied to the surface by applying masking tape to one or more edges (usually the top edge) of the stencil panel, and, when the stencil panel is properly aligned, attaching the stencil panel to the surface using the transfer tape by pressing it through the openings. In this manner, the stencil panels may be moved and positioned properly on the surface. Once properly positioned, the transfer tape is removed, the stencil panel is lifted up (it being held to the surface by the masking tape), the backing covering the adhesive on each stencil panel is removed, and the stencil panel is applied to the surface by the adhesive backing. The masking tape is then removed.

### Example 1

The procedure below was used for plane number 9345 at Mid Coast Aviation (now Jet Aviation). This plane model was a Bombardier Global.

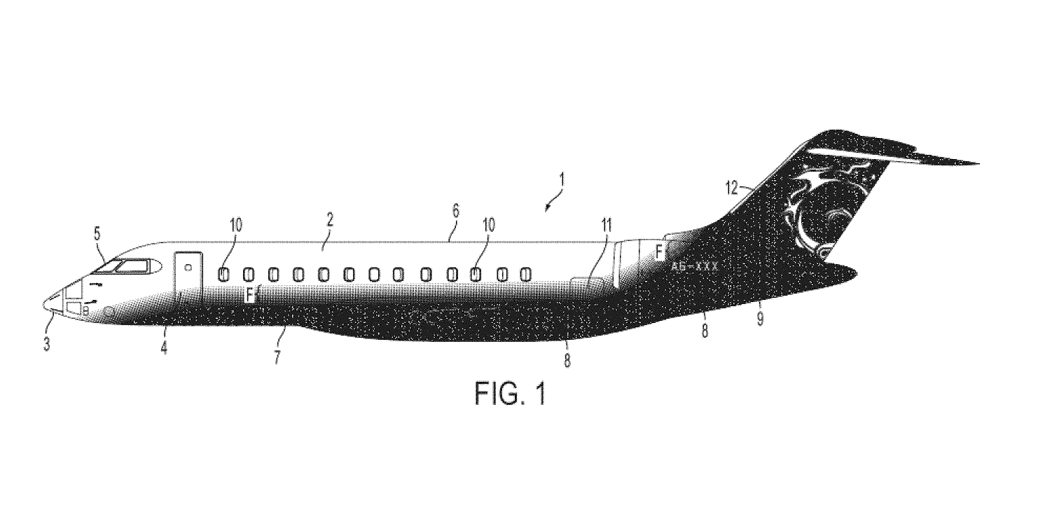

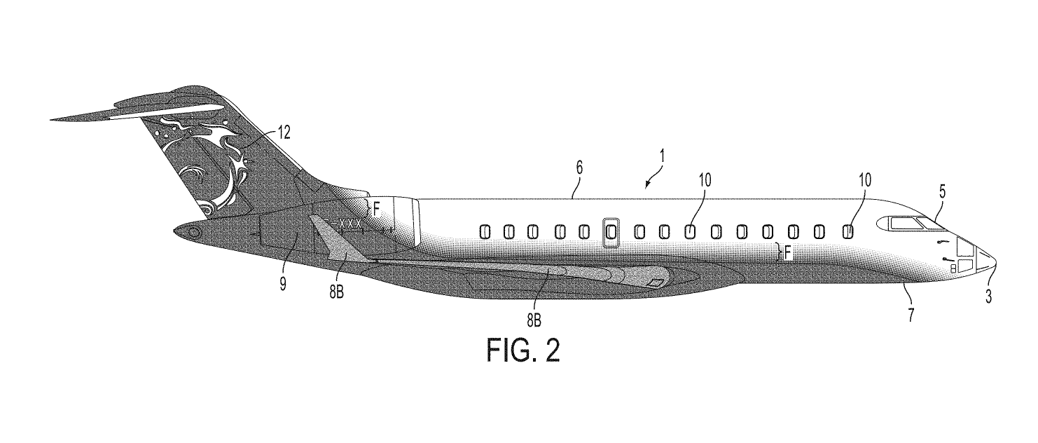

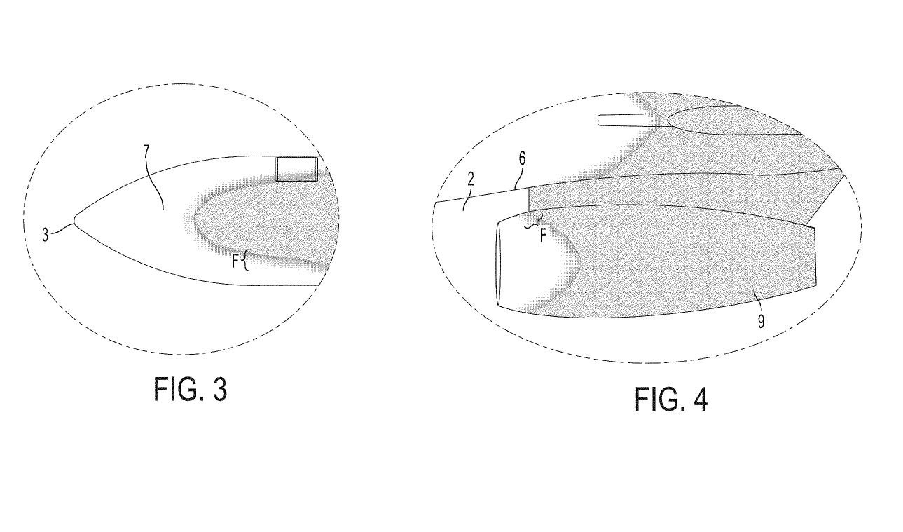

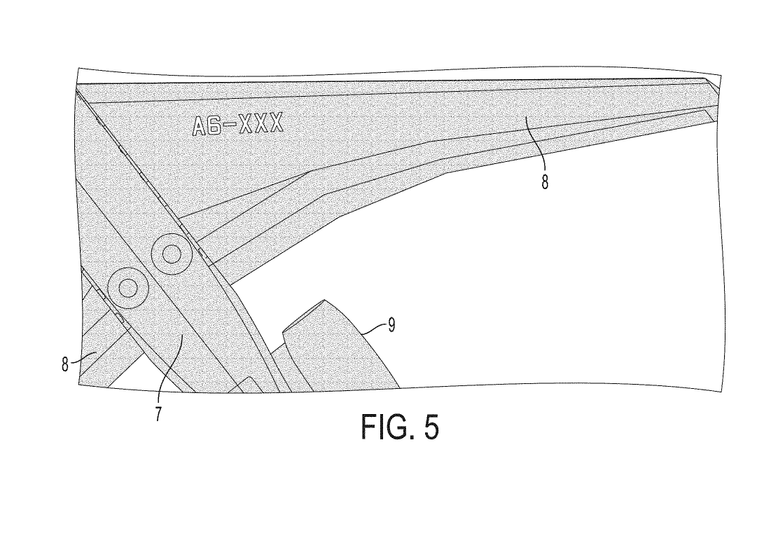

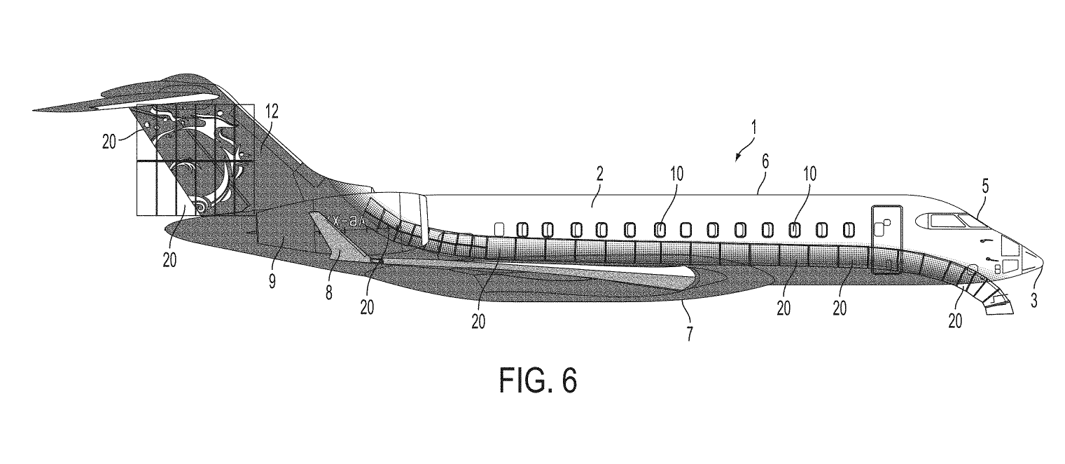

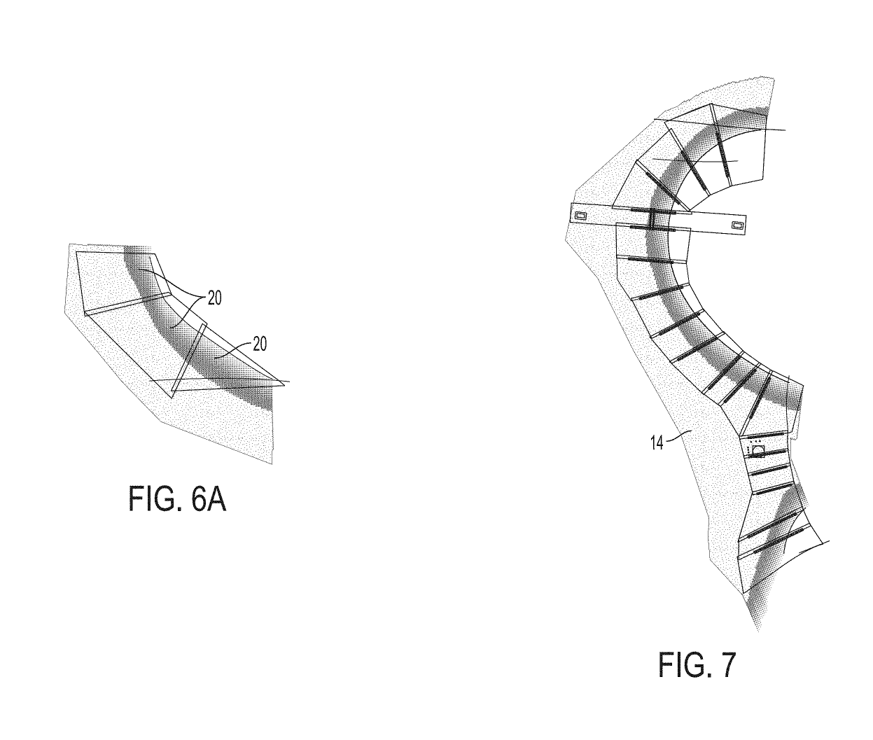

FIG. 1 shows a computerized rendering of a plane having stencil panels superimposed on it to create a fade pattern F. Plane 1 has a fuselage 2, a nose portion 3, a doorway 4, a pilot's window 5, a top 6, a bottom 7, wings 8, engine cowlings 9, passenger windows 10, a hatch 11, and a tail section 12. Fade pattern F is based upon an artist's desired aesthetic result. FIG. 2 shows the opposite side of the airplane rendering of FIG. 1, which also shows the fade pattern F. FIG. 3 shows the lower nose detail of the rendering of FIG. 1. FIG. 4 shows the top nacelle detail of the plane rendering of FIG. 1. FIG. 5 shows the left, under wing detail of the plane rendering of FIG. 1. As can be seen, no fade pattern is applied to the under side of the wing in this example. FIG. 6 shows the plane rendering of FIG. 1 with images 20 of stencil panels 30 imposed thereon. FIG. 6A shows a rendering of stencil panels applied to the air scoop section 15. FIG. 7 shows an expanded view of the right cowling 14 of the rendering of plane 1 with images 20 of pre-panels 25 imposed thereon.

FIG. 8A is a line 80 for generating a fade pattern according to the invention. In the preferred embodiment, such a line, and other lines are formed by a computer program onto each stencil panel image 20 that is to be used to create a stencil panel 30 that will help create the fade pattern F. Each line is comprised of a multitude of openings 82 that are larger, and interconnected, at one end of the line, and gradually become smaller, and are not interconnected, at the opposite end. In this example, the openings 82 are diamond shaped, although any suitable shape can be used.

FIG. 8B is a plurality of the patterns of FIG. 8A spaced 0.9″ horizontally. FIG. 8C shows a preferred method for extending the fade pattern around a curve wherein in this preferred embodiment, each line moves 0.9″ horizontally and 0.964″ vertically. FIG. 8C shows one embodiment for placing the fade pattern F onto a compound-curved surface. In this example, to create the appearance of a curve, each line 80 is moved vertically (upwards or downwards, depending on the direction of the curve) by 0.964″ and horizontally by 0.9″. These dimensions could be altered by an operator based on the desired appearance of the fade pattern.

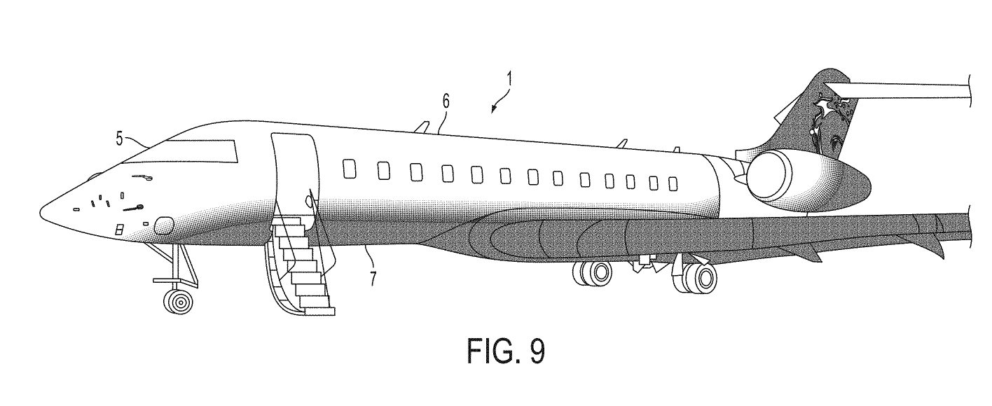

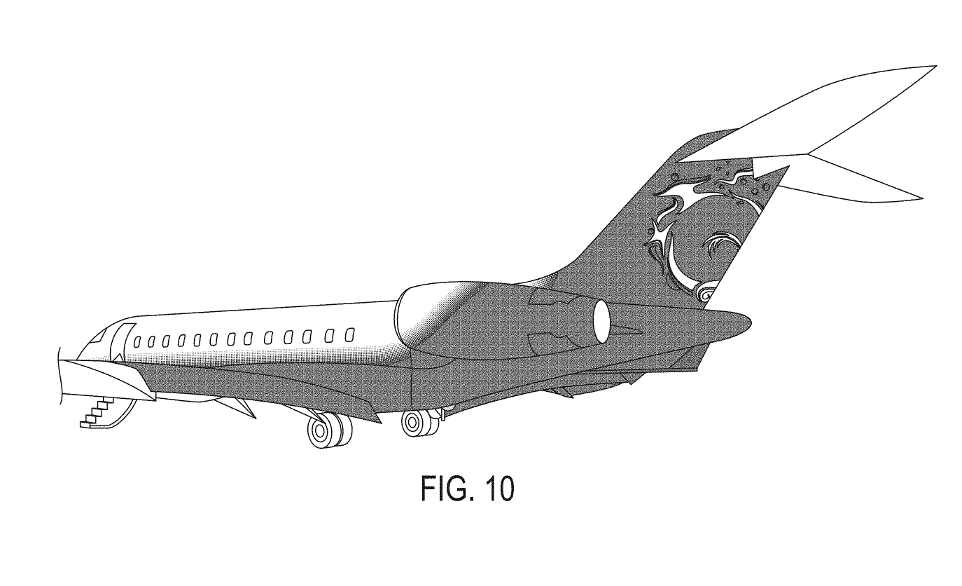

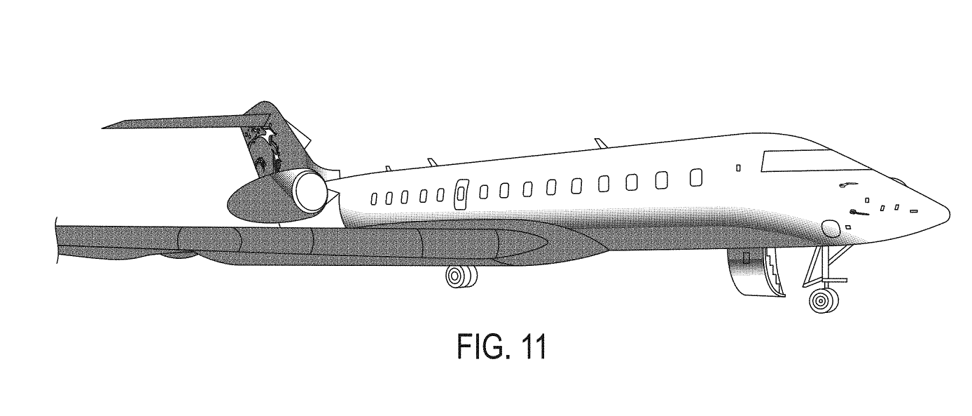

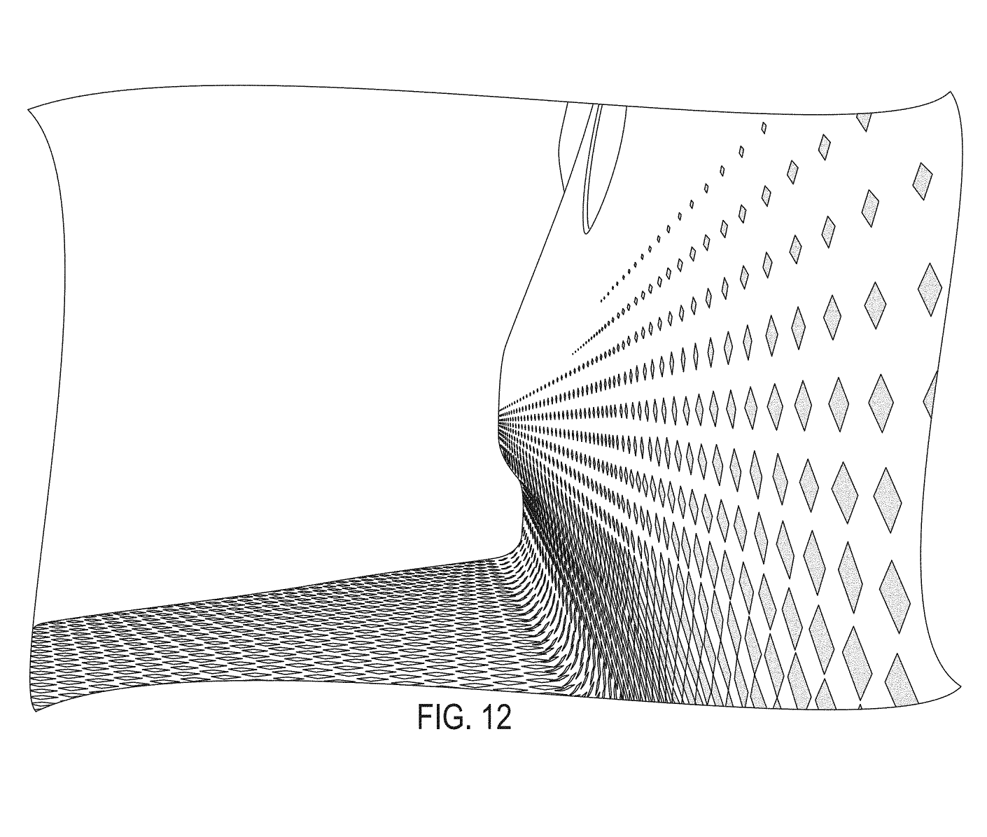

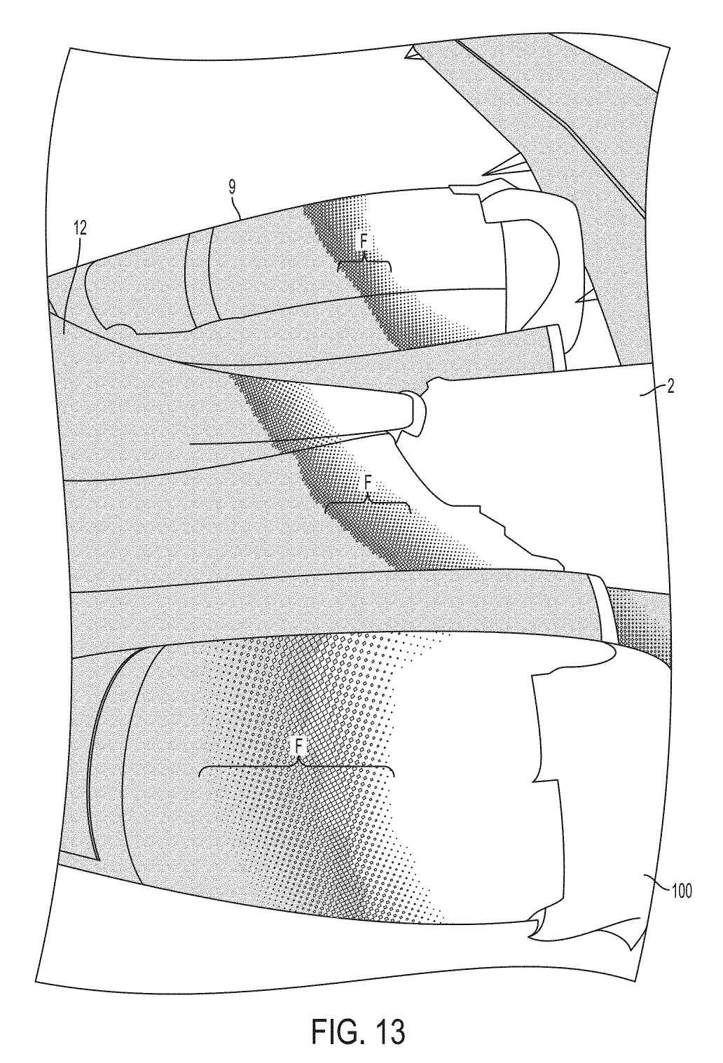

FIG. 9 shows a plane masked with paper to form pre-panels to create a fade pattern. FIG. 10 shows the plane of FIG. 9 with paper pre-panels on the back end. FIG. 11 shows a side view of the plane of FIG. 9. FIG. 12 is a close-up view taken along the side fuselage of the plane of FIG. 9. FIG. 13 is a top view showing the plane of FIG. 9 with masking on it and with a fade pattern applied.

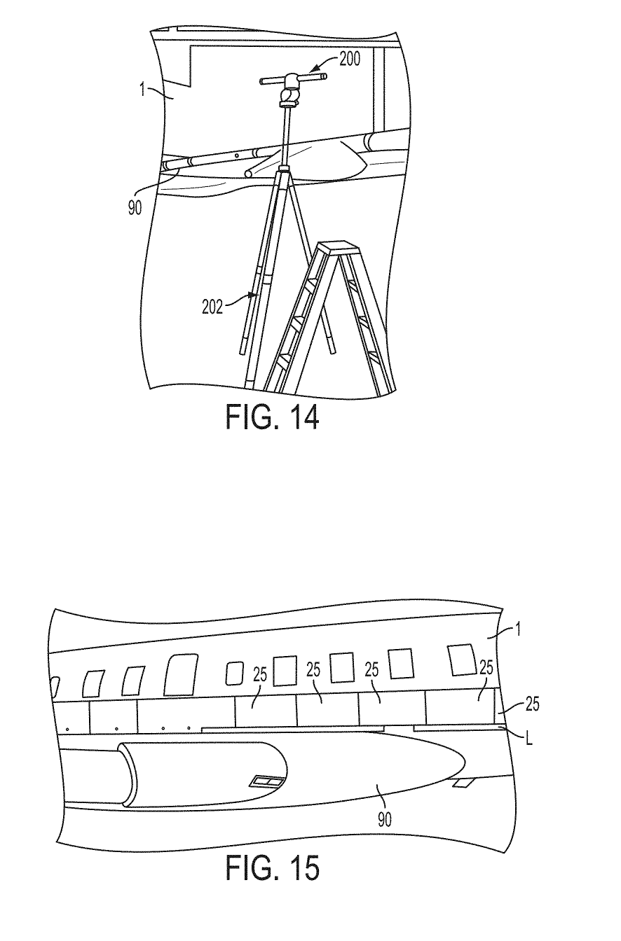

FIG. 14 shows an example of a laser that can be used to create a fade line, and that can also be used to re-align the fade pattern when the stencil panels are applied to the surface. It can also be used to align and apply mock stencil panels.

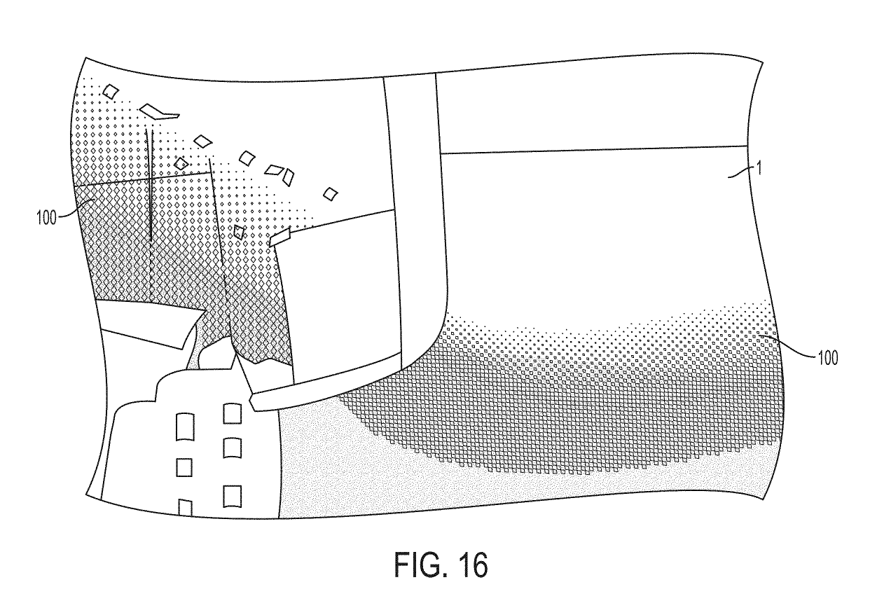

FIG. 15 shows a fade line, L being drawn onto pre-panels 25. FIG. 16 shows the finalized pattern applied to the plane surface using mock panels 75, which in this case are paper panels with the fade pattern printed thereon.

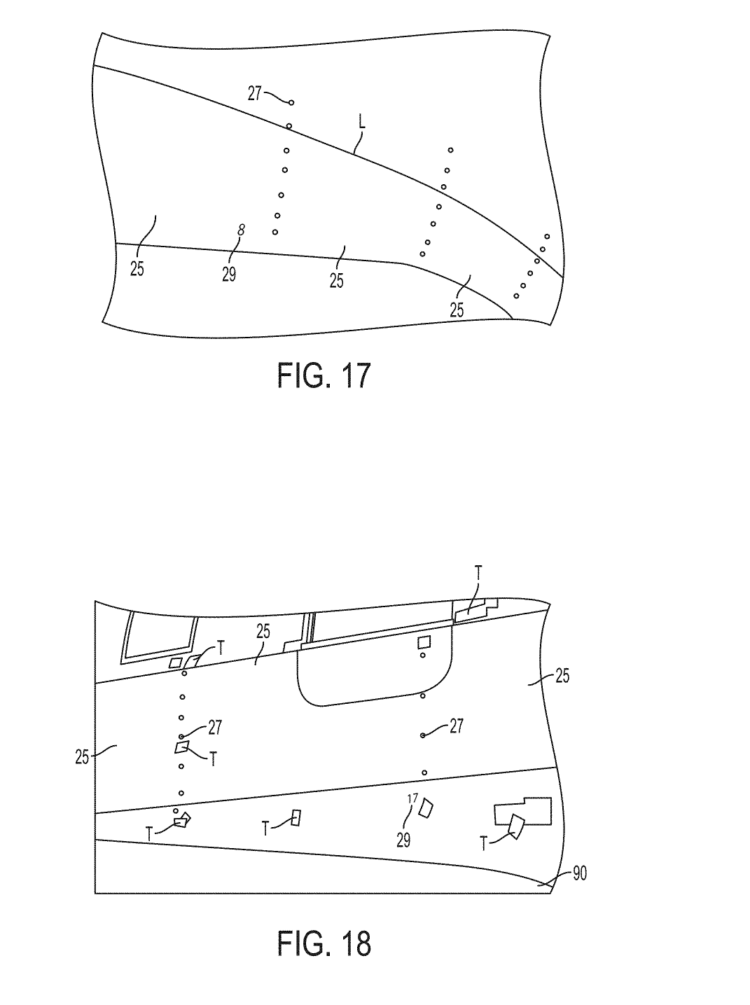

FIG. 17 is The beginning is mapping the planes surface. In this example we used a laser line to start our fade line. When then attached a custom scaled grid pattern paper and we then take and cut the paper to form around the outside of a surface.

From there we hand draw red line into the paper with marker to represent the final fade line from the top of the fade. We also mark and measure any panels, hatches, doors and more for re-alignment purposes.

FIG. 18 shows pre-panels 25 applied to the surface with marks and indicia to align each pre-panel (and corresponding stencil panels) and to shape and align each pre-panel with relevant, nearly structures on the surface. This information will be used in forming the corresponding stencil panels.

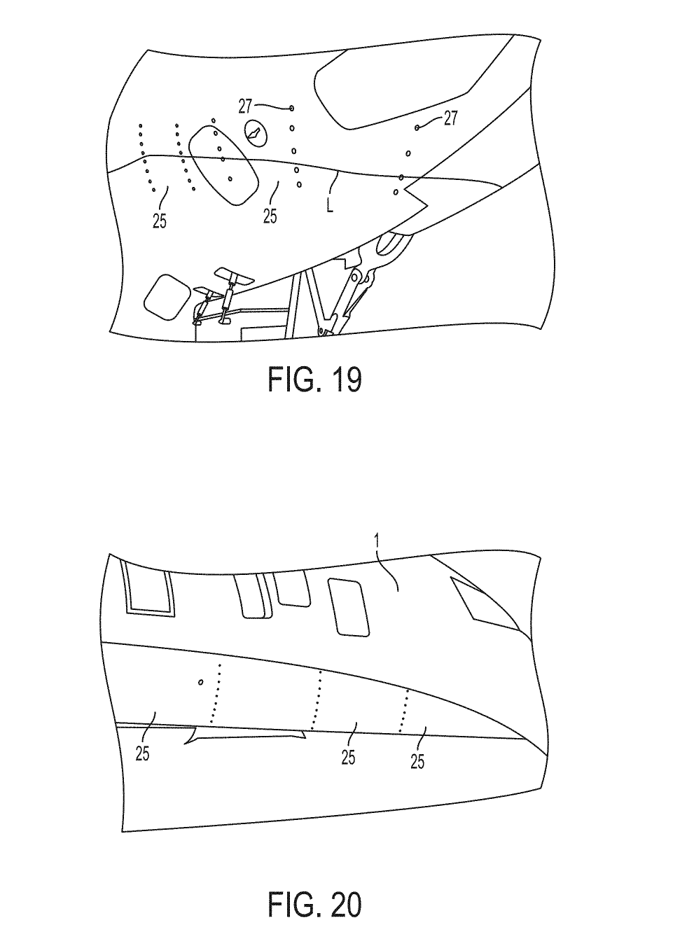

FIG. 19 shows pre-panels 25 on the bottom of the fuselage with a fade line L marked thereon. FIG. 20 shows pre-panels 25 placed near the front of the plane fuselage and being marked with relevant indicia.

### Modeling the Fade Pattern

In this Example, the plane was about 100 ft. long allowing for the creation of a scaled version of the art to be enlarged to match the plane's full size. The scaled version was created by scanning an image of the plane into a computer program and then modeling the manner in which the fade pattern would appear (such as by using ADOBE ILLUSTRATOR). The fade pattern was modeled on the surface of the plane, including on the compound-curved surfaces.

### Mapping of the Plane with Pre-Panels

At this point, the surface to which the fade pattern is to be applied was mapped using paper pre-panels, as previously described. In this example, the fade pattern wrapped from under the nose of the plane (see, e.g., FIGS. 1-3, 6) down the fuselage (see, e.g., FIGS. 1-3, 9 and 12), and wraps around and on top of the engines, and on top of the tail, as shown, for example, in FIGS. 1-2, 6 and 6A. One or more of the first fade line (shown, for example, in FIG. 18) and second fade line (shown, for example, in FIGS. 15 and 17-20) was created and projected (shown, for example, in FIG. 14) using a laser along the surface of the plane to establish the fade line.

Multiple pieces of paper were then formed to create pre-panels with grid lines (in this example, the lines formed 2″×2″ grids) based on scale to the rendering shown in FIGS. 1-6, and were taped to the surface of the plane, as shown in FIGS. 6, 6A, 7 and 12. The first fade line was then projected, and drawn, onto each relevant pre-panel. Alternatively, one or both of the respective fade lines for each section of the plane that received the fade pattern could have been measured and drawn onto the pre-panels. As previously explained, often only the first fade line or the second fade line must be established, since once the width of the fade pattern has been determined and will determine the position of the other fade line. This is correct except for compound-curved surfaces. The size, number and position of openings required to create the fade pattern can be determined by the computer program, as adjusted by a human operator to achieve the desired final appearance.

When the pre-panels are attached to the plane, if appropriate for proper creation of the stencil panels that will create the fade pattern, seams, doors, openings, windows and other irregularities in the plane's surface are marked (or mapped) onto the pre-panels, if necessary to create the stencil panels. If the fade pattern, for example, is beneath or above such structures, the structures likely do not need to be mapped because they are irrelevant to the shape, size and location of the stencil panels that will be used to create the fade pattern.

In this example, the pre-panels were the same on both sides of the plane, because each side of the plane was the same. Therefore, only side had to be mapped with the pre-panels.

Once everything relevant was marked onto the pre-panels, and the fade line was drawn onto each relevant pre-panel, the pre-panels were numbered and one or more registration marks were placed on each relevant pre-panel to show where it aligns with each adjacent pre-panel. The registration mark(s) may be squares and/or circles or any suitable mark.

### Scanning the Pre-Panels and Applying the Fade Pattern

The pre-panels are then removed from the plane, and each pre-panel is then scanned (preferably by using a large blueprint scanner) into a computer program of the type previously described.

After scanning each pre-panel, one continuous stencil section is formed by the computer program by opening each scanned pre-panel image into a program such as PHOTOSHOP. Then, based on the fade line and width of the fade pattern, ADOBE ILLUSTRATOR added the openings that create the fade pattern to the image of the entire, continuous section, adding markings showing the size and shape of each stencil panel, and added the reference points, alignment marks, and stencil panel numbers necessary to properly place each stencil panel on the surface. Once the fade pattern (e.g., its shape, size and location) had been established by the operator, the fade pattern provided the basis for the size, location of number of each opening in the continuous stencil. For this example, the fade pattern had a width of 19″ inches from the largest opening 82 to the smallest opening of 82, which was the width of the fade pattern along the fuselage. For each opening, as shown in FIGS. 8A-8D, the largest width was 1″ and the smallest was ⅛″. These widths can be modified by a user according to the section of the surface to which the fade pattern is being applied, and to the desired esthetics.

Next the fade pattern for the compound-curved surfaces was finalized. These portions of the overall fade pattern were based on measurements taken from the pre-panels, the desired 19″ fade pattern width on the fuselage, and then visually adjusting the width of the fade pattern on the compound-curved surfaces, and visually adjusting (using a computer program) the position of the lines of openings to move the fade pattern along the compound-curved surface, in order to create an appearance that was visually consistent and pleasing when viewing the plane from the side. In this case, the fade pattern along the compound-curved surfaces was as wide as 25″, instead of the 19″ width used along the plane fuselage, in order to create the desired esthetics.

The pattern of the openings that form the fade pattern might also be modified based on subjective, esthetic qualities determined by an individual. In this Example, the established width of the fade pattern was initially 19″ along the entire fade line, but when the fade pattern was reviewed for esthetics before being applied to the plane, the width of the fade pattern was increased by as much as 25″ along the compound-curved surfaces (as stated above) to achieve the desired, visual esthetics. This type of modification usually only occurs in the places where the fade pattern goes across a compound curve or another complex surface, such as the intersection of the fuselage with a wing or engine.

Afterwards, an optional test may be run to determine the visual appeal of the fade pattern. For example, a continuous piece of material with the openings, reference points and markings may be created by the computer program communicating with a press to punch the holes that create the fade pattern and a printer that prints the reference points and marks onto a continuous material. The material (which is preferably paper) may be placed against a surface for review, or it could be cut into individual pieces, which have the same respective dimensions as the stencil panels would have. In this case, the continuous material was cut into individual pieces, and each individual piece of paper was then re-aligned with the fade line on the plane and taped onto the plane in the same position as the corresponding stencil panel would be located. These paper pieces acted as a prototype to check the alignment on the surface to which the fade pattern was to be applied prior to creating the actual stencil panels, and helped to ensure that the fade pattern was correct and esthetically acceptable prior to incurring the cost of creating the stencil panels from a material such as the vinyl mask. This process step may be repeated until the fade design is esthetically acceptable.

As with respect to forming the paper pieces as described in the preceding paragraph, the stencil panels are created in the same manner using the vinyl mask, with registration marks, numbering, notes, and alignment lines. When the computer program places the pattern on the vinyl mask, it causes the openings to be punched to be marked (such as with a color) and causes all of the indicia and markings to be placed on the vinyl mask. The cut opening portions are then removed by hand. These colorized portions are contour cut from printer/cutter, and are later removed by hand, and the vinyl mask is cut into individual stencil panels. Transfer tape is then preferably applied to each stencil panel.

For this example, 146 panels (73 on each side) were created, times two for a total of 292 stencil panels. In this instance, two sets of stencil panels were created in case a mistake was made during installation and a panel was damaged, so a total of 292 panels were created. Creating extra stencil panels is optional.

### Installation

Once the individual stencil panels were created, transfer tape was applied to the side of each panel (since each panel included openings to form the fade pattern) opposite the side with the adhesive backing. The surface of the plane was cleaned, washed, and was then cleaned with alcohol before the stencil panels were applied to the surface to allow for a better adhesion of the stencil panels to the surface of the plane. The existing white paint was lightly sanded to create a roughened surface.

The stencil panels were then taped to the plane using masking tape along the top edge of each stencil panel to position each stencil panel on the surface. Once it was determined that each stencil panel was properly positioned, the transfer tape was pressed against the surface through the openings in each stencil panel to hold the panel against the surface. Each stencil panel was positioned and aligned on the surface using its number and the indicia that showed how each aligned with adjacent stencil panels and with any irregularities in the plane surface. The stencil panels could also have been aligned by projecting the fade line onto the surface and then aligning the fade line position on each stencil panel with the fade line.

Once all the stencil panels were taped onto the plane and were determined to be properly aligned, the backing on each of the stencil panels was removed and each stencil panel was then directly adhered to the plane by the adhesive on each stencil panel. Each stencil panel was pressed against the plane surface using a squeegee to ensure proper adhesion, although the use of a squeegee or similar device is optional. The masking tape was then removed. In this embodiment, going from the nose of the plane towards the tail, with the nose to the left of the tail, each stencil panel overlapped the stencil panel to its left by about an inch.

### Painting

The stencil panels were then painted using a paint spraying device known to those skilled in the art. The paint may be sanded after it dries by sanding the stencil panels to break the tension (because the paint is on the stencil panels, the walls of the openings of the stencil panels, and the surface) so the paint on the plane's surface does pull off when the stencil panels are removed. This allows for easier release of the stencil panels from the painted surface.

### Removal

Once the plane was painted and the paint cured, which is usually determined by time and touch—for the paint used in this example, when it felt soft, but did not leave a fingerprint, the stencil panels were removed. Removal is usually easier before the paint fully dries. A plastic tool called a chizzler, which is a hard, angled plastic piece, was used to help in removal of the stencil panels.

### Detailing

Once the stencil panels were removed from the plane, there were some areas where the paint seeped around the holes in a stencil panel and created a fuzzy edge of paint instead of a clean, sharp edge. Detailing to make such lines sharp can be done in any manner. One way to do it is to use a metal exacto knife or other sharp tool to scrap off the excess paint that creates the fuzzy edge, in order to re-expose the first layer of paint. Alternatively, an individual may touch up any fuzzy areas with paint using a paint brush.

### Final Clear Coat of Paint

Once the plane has been painted, the paint was covered with a clear coat to protect the paint underneath, although this step is optional.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A paint coating applied to a surface to form a fade pattern, the surface having at least one compound-curved surface; the coating of paint applied by the method of attaching a plurality of stencil panels to the surface wherein at least one of the stencil panels is configured to fit on the at least one compound-curved surface without wrinkling or buckling, so that at least part of the fade pattern is applied to the at least one compound-curved surface.

2. The paint coating formed by the method of claim 1 that further includes the steps of forming pre-panels and applying them to the surface, applying indicia to the pre-panels, scanning the pre-panels into a computer program, and forming the stencil panels based upon the scanned pre-panels with indicia.

3. The paint coating formed by the method of claim 2 wherein the step of placing pre-panels on the surface comprises placing pre-panels on the at least one compound-curved surface so that the pre-panels on each of the at least one compound-curved surface completely cover it.

4. The paint coating formed by the method of claim 2 wherein the pre-panels are comprised of paper.

5. The paint coating formed by the method of claim 2 wherein each of the pre-panels is numbered and has indicia to align it with any adjacent pre-panels.

6. The paint coating formed by the method of claim 1 that further includes the step of removing the plurality of the stencil panels from the surface after paint is applied.

7. The paint coating formed by the method of claim 1 that further includes the steps of:
determining the position of one or more of: a first fade line and a second fade line on the surface;
determining the width of the fade pattern on the surface, the width being between the first fade line and the second fade line;
inputting the position of: one or more of the first fade line and the second fade line into a computer program;
inputting the width of the fade pattern into the computer program;
the computer program determining the location, size, spacing and number of openings necessary to create the fade pattern on the surface; and
the computer program communicating with a machine that creates the openings in a continuous piece of stencil material.

8. The paint coating formed by the method of claim 7 wherein the computer program determines the number of the plurality of stencil panels required to create the fade pattern on the surface, and the size, number and position of holes for each of the plurality of stencil panels.

9. The paint coating formed by the method of claim 8 that further includes the steps of:
placing pre-panels on the surface;
placing on the surface one or more of the first fade line and the second fade line;
placing indicia on each of the pre-panels sufficient to identify where the pre-panel was positioned on the surface and to align it with adjacent pre-panels;
scanning each of the pre-panels into the computer program to create inputted information; and
the computer program configuring a continuous stencil material utilizing the inputted information.

10. The paint coating formed by the method of claim 2 that further includes the step of removing the pre-panels from the surface before they are scanned.

11. The paint coating formed by the method of claim 9 that further includes the step of removing the pre-panels from the surface before they are scanned.

12. The paint coating formed by the method of claim 7 wherein the method further includes the step of the operator adjusting the location and number of openings are adjusted by an operator adjusting the width of the fade along at least part of the surface.

13. The paint coating formed by the method of claim 7 wherein the method further includes the step of determining one or more of the first fade line and the second fade line based on an artist's rendering of the fade pattern on the surface.

14. The paint coating formed by the method of claim 9 wherein the method further includes the step of placing one or more of the first fade line and the second fade line on at least some of the pre-panels by using a laser to project one or more of the group consisting of: the first fade line and the second fade line.

15. The paint coating formed by the method of claim 7 wherein the continuous piece of stencil material is formed of vinyl.

16. The paint coating formed by the method of claim 7 that further includes the step of placing indicia on each pre-panel to align it with each adjacent pre-panel on the surface, the indicia input into the computer program and included on the continuous piece of stencil material.

17. The paint coating formed by the method of claim 7 wherein individual stencil panels are formed from the continuous piece of stencil material.

18. The paint coating formed by the method of claim 7 wherein the openings are aligned in one or more of the group consisting of: vertical columns and horizontal rows.

19. The paint coating formed by the method of claim 17 wherein the openings are aligned in vertical columns and each column is positioned so it is between 0.5″ and 2.0″ lower or higher than each adjacent column on each of the individual stencil panels positioned on a compound-curved surface.

20. The paint coating formed by the method of claim 7 wherein the openings are aligned in horizontal rows and each row is positioned between 0.5″ and 2.0″ from each adjacent row.

21. The paint coating formed by the method of claim 19 wherein the openings are also aligned in horizontal rows and each row is positioned between 0.5″ and 2.0″ from each adjacent row.

22. The paint coating formed by the method of claim 9 wherein the step of placing pre-panels on the surface comprises placing pre-panels on one or more compound-curved surfaces to which the fade pattern is to be applied, so that the pre-panels on each of the one or more compound-curved surfaces completely cover each of the one or more compound-curved surface.

23. The paint coating formed by the method of claim 1 wherein the fade pattern has a width and the width varies.
